(19) United States
(12) Patent Application Publication
(10) Pub. No.: US 2003/0154571 A1
(43) Pub. Date: Aug. 21, 2003

(54) Simple magnetic hinge

(76) Inventors: Yu-Lin Hsiang, Hsin Tien City (TW); Chin-Chang Lin, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/080,998

(22) Filed: Feb. 19, 2002

(51) Int. Cl. E05D 11/10

(52) U.S. Cl. 16/320

(57) ABSTRACT

The present invention provides a simple magnetic hinge using a magnet placed in a moveable object to attract a metal piece disposed in a fixed object on the other side; both of the objects are assembled into an unit by a rivet; when the external force exerted on the movable object is greater than the magnetic force of the magnet for attracting the metal piece, these two objects are separated to hinge or move; when the external force exerted on the movable object disappears, these two objects stay at their original positions, tightly joint together and can't be separated.

### BACKGROUND OF THE INVENTION

1) Field of the Invention

The present invention provides a simple magnetic hinge, more especially a hinge suitable for general electronic products; the magnetism is used to joint two objects; when the exerted external force is greater than the magnetic force, these two objects are separated to hinge or move; when the external force disappeares, these two objects can't be turned or moved due to the magnetic and tight joint.

2) Description of the Prior Art

Accordingly, the conventional hinges applied to lightweight electronic products, such as a notebook computer, a LCD monitor, etc., are mechanically clamped to adjust the moving or hinging angles of two objects; after a long-term of application, the complicatedly assembled parts of the mechanical hinges tend to be mechanically fatigue and result in breakdown; therefore, these conventional hinges are not ideal products and need improvement.

### SUMMARY OF THE INVENTION

The primary objective of the present invention is to provide a simple magnetic hinge using magnetic force to hinge or move two objects to be suitably applied to general electronic products; when the external force exerted on a movable object is greater than the magnetic force attracting these two objects, the said movable object can be moved or turned; when the external force exerted on the movable object is released, the movable object maintains at the current position.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is an external view drawing of the present invention.

FIG. 2 is a cross-sectional drawing of the present invention.

FIG. 3 is a lateral view drawing of the present invention.

FIG. 4 is the first drawing of an exemplary embodiment of the present invention.

FIG. 5 is the second drawing of an exemplary embodiment of the present invention.

FIG. 6 is the third drawing of an exemplary embodiment of the present invention.

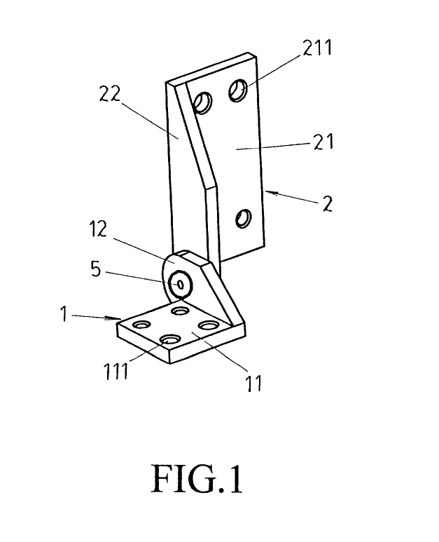

### DETAILED DESCRIPTION OF THE PREFERRED EMBODIMENTS

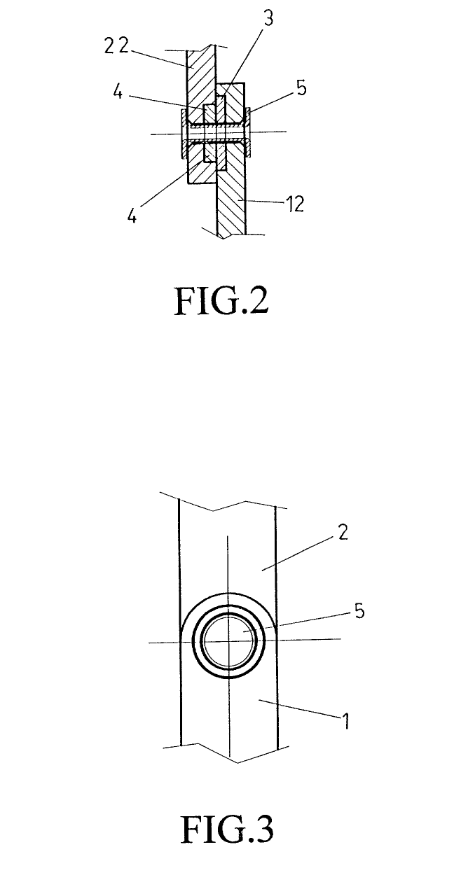

Referring to all of the Figures, the present invention comprises a fixed object (1), a movable object (2), a metal piece (3), a magnet (4) and a rivet (5); wherein, the fixed object (1) can be made of plastic, metal or other kinds of material; the strength thereof is big enough to support the exerted force thereon; on a fixed end (11) of the L-shaped fixed object (1), a plurality of fixed holes (111) are disposed to be fastened by bolts to joint the screen and the bottom portion of an LCD monitor; referring to FIG. 2, the metal piece (3), such as a SLSC steel material, is disposed inside the jointing end (12) on the other end of the fixed object (1); the material of the movable object (2) is the same as that of the fixed object (1) and the shape of the movable object (2) is also in an L-shape; the fixed end (21) on one side thereof is disposed with a plurality of fixed holes (211) to be fixedly fastened by bolts to joint the movable LCD monitor screen; a magnet (permanent magnet) (4) is placed inside the jointing end (22) on the other end thereof, as shown in FIG. 2.

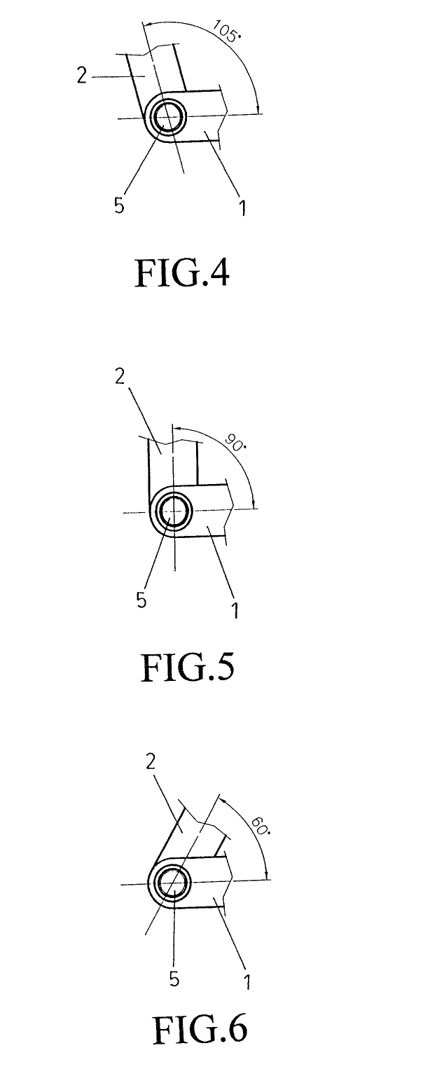

The said fixed object (1) and the movable object (2) are respectively penetrated by the rivet (5) for fastening the jointing ends (12, 22) of the fixed object (1) and the movable object (2) into one unit; the magnet (4) inside the movable object (2) and the metal piece (3) inside the fixed object (1) attract each other and tightly joint together; when the external force exerted on the movable object (2) is greater than the magnetic force of the magnet (4) for attracting the metal piece (3), the movable object (2) can be hinged or moved; when the external force is less than the magnetic force, it can't be hinged or moved; as shown in FIGS. 4 to 6, the movable object (2) can be turned to respectively form various positions at 105°, 90° or 60° according to the need of exertion; when the external force exerted on the movable object (2) disappears, the movable object (2) immediately positions at the current angle and attracts the fixed object (1) again; unless a force greater than the magnetic force is again exerted onto the movable object (2), these two objects (1, 2) remain tightly jointed and can't be separated.

The abovementioned are only preferred embodiments of the present invention, the hinge mechanism can also be an assembly of a fixed object (1) disposed with a magnet (4) therein and a movable object (2) disposed with a metal piece (3) therein.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A simple magnetic hinge comprises a fixed object, a movable object, a metal piece, a magnet and a rivet; wherein, the metal piece is placed inside the fixed object and the magnet is disposed inside the movable object; the magnet attracts the metal piece; the fixed object and the movable object are penetrated and fastened by the rivet into one unit; when the external force exerted onto the movable object is greater than the magnetic force of the magnet for attracting the metal piece, the movable object and the fixed object are separated to hinge or move; when the external force disappears, these two objects again tightly joint together and can't be turned or moved.

2. A simple magnetic hinge according to claim 1, wherein the fixed object and the movable object are respectively in an L-shape and disposed respectively with a fixed end and a jointing end; the metal piece and the magnet are respectively placed into the jointing ends of the said two objects and are assembled by means of the rivet into one unit.

3. A simple magnetic hinge according to claim 1, wherein the hinge can also be an assembly of a fixed object disposed with a magnet and a movable object disposed with a metal piece.
